(19) United States
(12) Patent Application Publication
(10) Pub. No.: US 2008/0284711 A1
(43) Pub. Date: Nov. 20, 2008

(54) Method and apparatus to automatically control power of address data for plasma display panel, and plasma display panel device including the apparatus

(76) Inventors: Ji-Hwan Seol, Suwon-si (KR); Woo-Jin Kim, Suwon-si (KR); Jung-Eun Park, Suwon-si (KR); Moo-Yong Hyun, Suwon-si (KR)

Correspondence Address: ROBERT E. BUSHNELL, 1522 K STREET NW, SUITE 300, WASHINGTON, DC, 20005-1202, US

(21) Appl. No.: 12/153,264

(22) Filed: May 15, 2008

(30) Foreign Application Priority Data
May 15, 2007 (KR) 10-2007-0047291

(51) Int. Cl. G09G 3/36

(52) U.S. Cl. 345/100

(57) ABSTRACT

A method and apparatus for automatically controlling power of address data in a plasma display panel (PDP), and a PDP device including the apparatus are provided. In this method, first, a difference-sum of pixel value differences between adjacent pixels successively arranged along a column of block is calculated. Then, an address power control level corresponding to the calculated difference-sum for each block is determined. Thereafter, gain information for each block on the basis of the address power control level for each block is determined. Next, a gain for each block corresponding to the gain information for each block is output. Then, the input image signal is multiplied by the gain for each block to correct the input image signal to output the corrected image signal. Accordingly, power consumption, noise, and generation of heat are reduced, and also the brightness is improved.

### CLAIM OF PRIORITY

This application makes reference to, incorporates the same herein, and claims all benefits accruing under 35 U.S.C. §119 from an application earlier filed in the Korean Intellectual Property Office on 15 May 2007 and there duly assigned Serial No. 10-2007-0047291.

### BACKGROUND OF THE INVENTION

1. Field of the Invention

The present invention relates to a plasma display panel (PDP) device, and more particularly to a method and apparatus to automatically control power of address data in a PDP, and a PDP device including the apparatus.

2. Description of the Related Art

Generally, PDPs require an apparatus to control power consumption in accordance with the load ratio of a frame to be displayed, because they consume a large amount of electric power due to driving characteristics thereof. Conventionally, such a power control is automatically carried out to reduce power consumption. In a contemporary method, however, such an automatic power control (APC) is carried out only for generation of sustain and scan pulses. That is, no APC is carried out for generation of address data. For this reason, contemporary PDPs have a drawback of large power consumption in their PDP parts to drive address data.

FIG. 1 is a diagram showing image data of a white-screen. Referring to FIG. 1, it can be seen that all pixels in the image data of the white-screen have a value of 1. In this case, accordingly, there is little or no data variation of address electrodes. Also, the number of pulse switching operations is small. Thus, the probability of generation of ineffective power during a charging or discharging operation is reduced, because power consumption increases in proportion to the number of switching operations. The driving waveform for the image data of the white-screen is shown in FIG. 2. As shown in FIG. 2, only one switching operation is required for each column of the image data of the white-screen, for example, a first column marked by a solid line in FIG. 1.

FIG. 3 is a diagram showing dot pattern image data. Referring to FIG. 3, it can be seen that the dot pattern image data has pixel values continuously varying between 1 and 0, so that it requires a number of switching operations. The driving waveform in this case is shown in FIG. 4.

As shown in FIG. 4, in the case of the dot pattern image data, there is a considerable data variation of address electrodes. Also, the pulse switching of the driving waveform is frequently made, thereby causing an increase in power consumption.

As described above, the switching operation is more frequently generated when the number of pixels having different values between neighboring lines of address data is larger. In this case, there is a problem of an increase in power consumption.

FIG. 5 is a diagram of an example of image data which is a mixture of white columns as shown in FIG. 1 and dot pattern columns as shown in FIG. 3. FIG. 6 is a diagram of another example of image data that is a mixture of white columns as shown in FIG. 1 and dot pattern columns as shown in FIG. 3.

Referring to FIGS. 5 and 6, the image data of the columns enclosed by a solid line has pixel values continuously varying between 1 and 0, so that it requires a large number of switching operations. The driving waveform for this image data is as shown in FIG. 4. Meanwhile, the image data of the other columns have pixels continuously having a value of 1, so that no switching operations occur. The driving waveform for this image data is as shown in FIG. 2.

As shown in FIGS. 5 and 6, in the dot pattern of the columns enclosed by the solid line, there is a big data variation of address electrodes, and the number of pulse switching operations is large. Thus, power consumption increases.

### SUMMARY OF THE INVENTION

The present invention provides a method and apparatus for automatically controlling power of address data in a plasma display panel (PDP), which are capable of reducing the number of switching operations for address data, and thus, reducing power consumption, while efficiently controlling brightness, heat, and noise, and a PDP device including the apparatus.

According to an aspect of the present invention, there is provided an apparatus to automatically control power of address data in a plasma display panel that includes a plurality of pixels for displaying an image, the pixels being arranged in a two-dimensional array having lines and columns. The apparatus including a memory to store sustain discharge information as a function of a load ratio, an average signal level sensor to measure a load ratio of an externally input image signal, a power controller coupled to the average signal level sensor and the memory, an address power controller receiving the input image signal, and an address data generator coupled to the address power controller. The input image signal represents pixel values for the pixels. The power controller reads sustain discharge information corresponding to the measured load ratio of the input image signal, and outputs the sustain discharge information. The two-dimensional array includes a plurality of blocks. Each of the blocks includes at least one column of the array. The address power controller calculates a difference-sum for each of the blocks. The difference-sum is calculated by adding differences between pixel values of neighboring pixels that are successively arranged along a column of the array and are included in the each of blocks. The address power controller obtains a gain for the each of the blocks on a basis of the difference-sum for the each of the blocks. The address data generator receives the input image signal. The address data generator multiplies the gain for each of the blocks by the input image signal corresponding to the each of the blocks to generate address data.

Each of the blocks may include only one column.

The address power controller may include a line memory to store the input image signal in units of blocks and lines, a sum calculator coupled to the line memory and calculating the difference-sum for each of the blocks, a gain storing unit to store a gain look-up table that includes a gain as a function of an address auto power control (APC) level, and a gain determiner coupled to the sum calculator and the gain storing unit. The gain determiner determines an address APC level corresponding to the difference-sum for the each of the blocks that is calculated in the sum calculator. The gain determiner reads a gain corresponding to the determined address APC level from the gain look-up table. The gain determiner outputs the gain for the each of the blocks.

The gain for each of the blocks may be inversely proportional to the difference-sum for the each of the blocks.

The address power controller may include a line memory to store the input image signal in units of blocks and lines, a sum calculator coupled to the line memory and calculating the difference-sum for each of the blocks, a gain storing unit to store a gain look-up table that includes a start gain, an end gain, and a sustain time, each of which is a function of an address auto power control (APC) level, and a gain determiner coupled to the sum calculator and the gain storing unit. The gain determiner determines an address APC level corresponding to the difference-sum for the each of the blocks that is calculated in the sum calculator. The gain determiner reads a start gain, an end gain, and a sustain time corresponding to the determined address APC level for each block from the gain storing unit. The gain determiner outputs a gain whose level is no greater than the start gain and no less than the end gain.

The gain may be decremented by a predetermined value from the start gain to the end gain. The gain sustains a level for the sustain time. Time necessary for the gain decreasing from the start gain to the end gain is shortened at a higher address auto power control level. A falling slope of the gain with time may be smaller at a lower address auto power control level.

The end gain is 1 when the difference-sum is 0. The end gain for each block decreases as the difference-sum increases. The end gain ranges between 0 and 1. The sustain time may be shortened as the address auto power control level increases.

When a block has N lines and M columns, the sum of line pixel value differences of image data for each block for one frame may be calculated by the following equation:

$$S = {\sum }_{I = 1}^{N} {\sum }_{J = 1}^{M} ( {P}_{i + 1 , j} - {P}_{i , j} )$$

where, “P” represents a pixel value, “i” represents a line, and “j” represents a column.

The address data generator may correct data of the image signal, convert the corrected image data signals into gray scale data signals, sort the gray scale data signals in accordance with gray scales thereof, arrange the sorted gray scale data signals to meet a predetermined driving sequence, and output the arranged data signals.

According to another aspect of the present invention, there is provided a plasma display panel device comprising a plasma display panel, a controller for receiving input image signal, an address electrode driver, and a sustain, and scan electrode driver. The plasma display panel includes a plurality of address electrodes, a plurality of sustain electrodes, and a plurality of scan electrodes arranged in pairs with the sustain electrodes. The plasma display panel includes a plurality of pixels for displaying an image, the pixels being arranged in a two-dimensional array having lines and columns. The controller outputs address data and sustain discharge information based on the input image signal. The address electrode driver applies, to the address electrodes of the plasma display panel, a voltage corresponding to the address data output by the controller. The sustain and scan electrode driver generates sustain pulses and scan pulses, based on the sustain discharge information output by the controller, and applies the generated sustain pulses and scan pulses to the sustain electrodes and scan electrodes, respectively. The controller includes the apparatuses described above.

According to another aspect of the present invention, there is provided a method of automatically controlling power of address data in a plasma display panel that includes a plurality of pixels for displaying an image, the pixels being arranged in a two-dimensional array having lines and columns, the two-dimensional array including a plurality of blocks, each of the blocks including at least one column of the array. The method comprises receiving externally input image signal, calculating a difference-sum for each of the blocks, determining an address power control level corresponding to the calculated difference-sum for each of the blocks, obtaining a gain for each of the blocks on the basis of the address power control level for each of the blocks, and multiplying the gain for each of the blocks by the input image signal corresponding to the each of the blocks to correct the input image signal. The difference-sum is calculated by adding differences between pixel values of neighboring pixels that are successively arranged along a column of the array and are included in the each of blocks.

Each of the blocks may comprise only one column.

The step of obtaining the gain for each of the blocks may include a step of looking up a gain look-up table that includes a gain as a function of an address auto power control (APC) level. The step of obtaining the gain for each of the blocks may include a step of looking up a gain look-up table that includes a start gain, an end gain, and a sustain time, each of which is a function of an address auto power control (APC) level. The gain has a level no greater than the start gain and no less than the end gain.

The end gain for each of the blocks decreases as the address auto power control level increases, and the sustain time for each block may be shortened as the address auto power control level increases.

The method may further comprises converting the corrected image signals into gray scale data signals, sorting the gray scale data signals in accordance with gray scales thereof, arranging the sorted gray scale data signals to meet a predetermined driving sequence, and outputting the arranged data signals.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a diagram showing image data of a white-screen;

FIG. 2 is a driving waveform for the image data illustrated in FIG. 1;

FIG. 3 is a diagram showing dot pattern image data;

FIG. 4 is a driving waveform for the image data illustrated in FIG. 3;

FIG. 5 is a diagram of an example of image data obtained by mixing white columns and dot pattern columns;

FIG. 6 is a diagram of another example of image data obtained by mixing white columns and dot pattern columns;

FIG. 7 is a block diagram illustrating a PDP device according to an exemplary embodiment of the present invention;

FIG. 8 is a block diagram illustrating a detailed configuration of a controller shown in FIG. 7;

FIG. 9 is a block diagram illustrating a configuration of an address power controller shown in FIG. 8 in accordance with an embodiment of the present invention;

FIG. 10 is a graph depicting an end gain for each block varying depending on the address automatic power control (APC) level for each block of FIG. 9;

FIG. 11 is a block diagram illustrating a configuration of the address power controller shown in FIG. 8 in accordance with another embodiment of the present invention; and

FIG. 12 is a graph depicting a variation of a gain for each block depending on the address APC level for each block of FIG. 11.

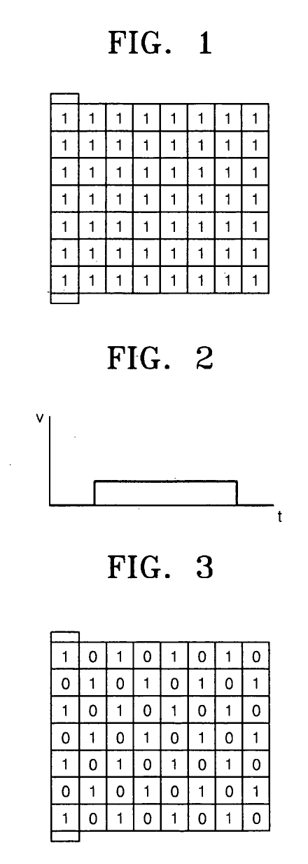

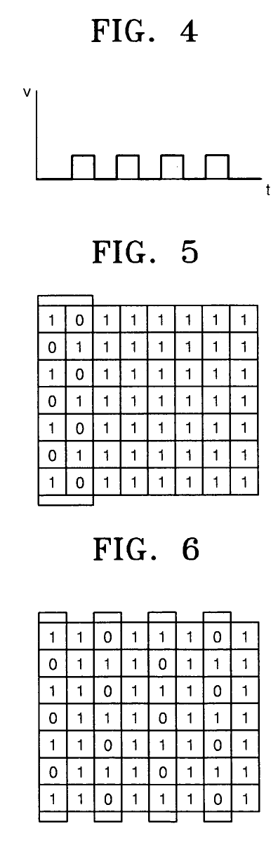

### DETAILED DESCRIPTION OF THE INVENTION

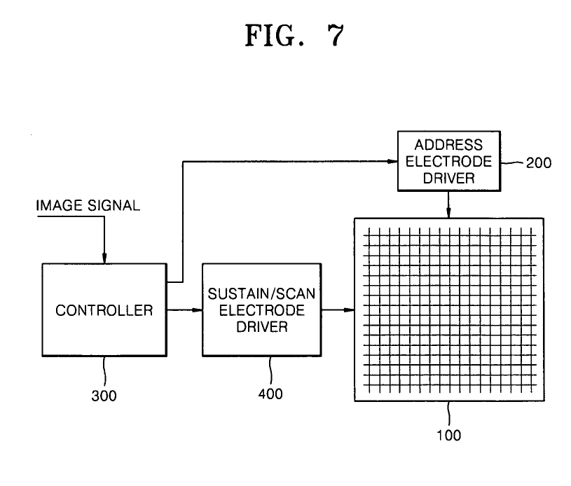

The present invention will now be described more fully with reference to the accompanying drawings, in which exemplary embodiments of the invention are shown. FIG. 7 is a block diagram illustrating a plasma display panel (PDP) device according to an exemplary embodiment of the present invention. As shown in FIG. 7, the PDP device includes a PDP 100, a controller 300, an address electrode driver 200, a sustain/scan electrode driver 400.

The PDP 100 includes a plurality of address electrodes, a plurality of sustain electrodes, and a plurality of scan electrodes. The sustain electrodes are arranged in pairs with the scan electrodes. The plasma display panel includes a plurality of pixels (or discharge cells) for displaying an image. The pixels are arranged in a two-dimensional array having lines and columns. The controller 300 generates address data and sustain discharge pulse information on the basis of received image data. The address electrode driver 200 applies, to the address electrodes of the PDP 100, a voltage corresponding to the address data output from the controller 300. The sustain/scan electrode driver 400 generates sustain pulses and scan pulses, based on the sustain discharge information output from the controller 300, and applies the generated sustain pulses and scan pulses to the sustain electrodes and scan electrodes, respectively, of the PDP 100.

Discharge cells of the PDP 100 are sorted into at least two blocks in units of a column of discharge cells that share an address electrode. The blocks may have an identical number of columns or different numbers of columns. Alternatively, each of the blocks may include one column of discharge cells. Each of the blocks includes at least one column of discharge cells.

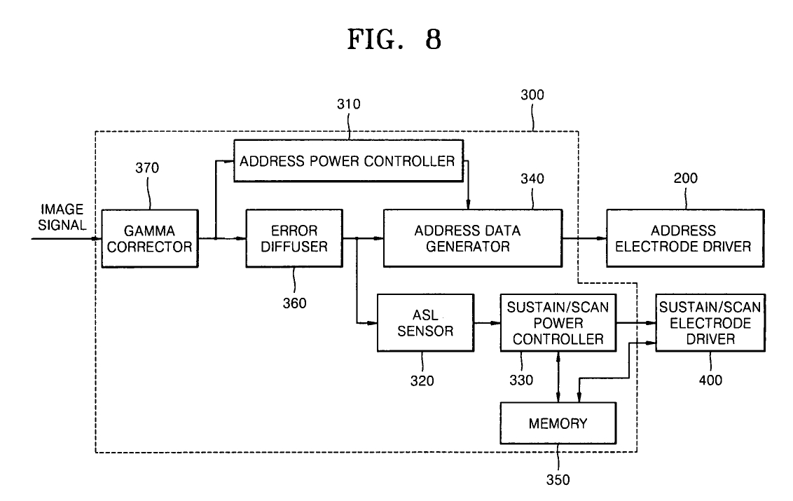

FIG. 8 illustrates an internal configuration of the controller 300 shown in FIG. 7. As shown in FIG. 8, the controller 300 includes an address power controller 310, an address data generator 340, a sustain/scan power controller 330, an average signal level (ASL) sensor 320, a memory 350, an error diffuser 360, and a gamma corrector 370.

The gamma corrector 370 performs a gamma correction for an input image signal. The error diffuser 360 performs error diffusion for the gamma-corrected image signal. The memory 350 stores sustain discharge information corresponding to the load ratio of the image signal. In other words, the sustain discharge information is a function of a load ratio. The ASL sensor 320 measures a load ratio of the error-diffused image signal. The sustain/scan power controller 330 outputs sustain discharge information corresponding to the load ratio of the currently input image signal. A pixel value of a pixel is represented by the input image signal. The address power controller 310 calculates a sum of differences of pixel values between neighboring pixels. Specifically, a difference of pixel values between pixels of adjacent lines in a column of a block are obtained, and the differences are added to obtain a difference-sum for the block. Then, the address power controller 310 determines gain information for each block, based on the calculated difference-sum for each block. The address power controller 310 then outputs a gain for each block corresponding to the gain information for each block.

The address data generator 340 generates address data by multiplying the image signal by the gains for respective blocks output by the address power controller 310, converts the address data into gray scale data signals, sorts the gray scale data signals in accordance with the gray scales thereof, arranges the sorted gray scale data signals to meet a predetermined driving sequence, and outputs the arranged data signals.

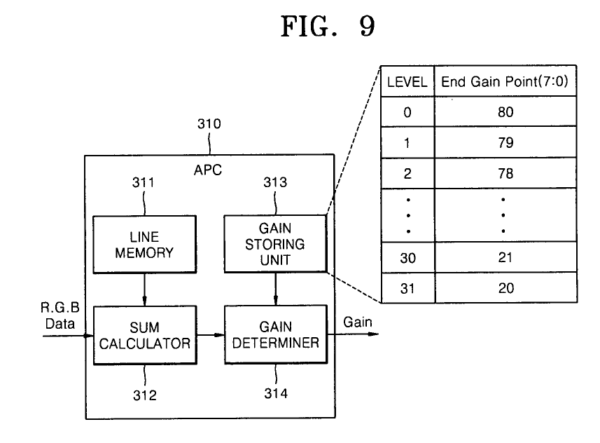

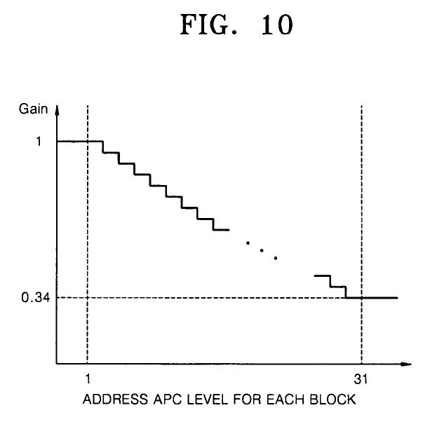

FIG. 9 is a block diagram illustrating a configuration of the address power controller 310 according to an embodiment of the present invention. As shown in FIG. 9, the address power controller 310 includes a line memory 311, a sum calculator 312, a gain storing unit 313, and a gain determiner 314.

Hereinafter, a method and apparatus to automatically control power of address data according to an embodiment of the present invention will be described in detail, along with an operation of the PDP device having the above-described configuration according to the illustrated embodiment of the present invention including the apparatus.

An image signal, which contains data components R, G, and B and sync signals Hsync (horizontal synchronization) and Vsync (vertical synchronization), is externally inputted. The gamma corrector 370 of the control unit 300 performs a gamma correction for the input image signal, and outputs the gamma-corrected image signal. The error diffuser 360 performs error diffusion for the gamma-corrected image signal.

The ASL sensor 320 measures the average signal level of the data components R, G, and B from the error-diffused image signal. The measured average signal level is applied to the sustain/scan power controller 330 as a load ratio.

The sustain/scan power controller 330 reads, from the memory 350, sustain discharge information corresponding to the load ratio measured by the ASL sensor 320, and outputs the read sustain discharge information to the sustain/scan electrode driver 400.

Based on the sustain discharge information, the sustain/scan electrode driver 400 reads, from the memory 350, the number of sustain discharge pulses corresponding to the load ratio. Based on the read number of sustain discharge pulses, the sustain/scan electrode driver 400 generates sustain pulses and scan pulses and applies the same to the sustain electrodes and the scan electrodes, respectively.

Meanwhile, the gamma-corrected image signal output from the gamma corrector 370 of the control unit 300 is also input to the address power controller 310. The sum calculator 312 of the address power controller 310 stores the image signal in the line memory 311 in units of blocks and lines, calculates pixel value differences between adjacent ones of the stored successive lines in each block of the image signal, and adds the calculated pixel value differences for each block. In this way, the sum of line pixel value differences in one frame for each block is derived. The difference-sum of line pixel value difference of one frame for each block can be calculated, using the following Equation 1.

$$S = {\sum }_{I = 1}^{N} {\sum }_{J = 1}^{M} ( {P}_{i + 1 , j} - {P}_{i , j} ) \qquad Equation 1$$

where, “P” represents a pixel value, “i” represents a line, and “j” represents a column. Using. Equation 1, it is possible to derive the sum of pixel value differences of adjacent ones of successive lines in image data corresponding to a block having N lines and M columns.

Equation 1 may be modified for various purposes. For example, Equation 1 may be modified to perform the calculation in units of lines or to calculate the sums of all lines at once.

The sum calculator 312 calculates, for each block, the pixel value difference between the previous line and the current line, the pixel value difference between the current line and the next line, the pixel value difference between the next line and the line after the next, through to the pixel value difference between an (N−1)th line and an N-th line, derives a sum S of the calculated pixel value differences, and outputs the derived sum to the gain determiner 314.

The gain determiner 314 determines an address automatic power control (APC) level for each block corresponding to the difference-sum S of each block, determines an end gain for each block corresponding to the determined address APC level for each block while referring to a lookup table stored in the gain storing unit 313, and outputs the determined end gain for each block. The end gain for each block, which varies depending on the address APC level for each block, is depicted in FIG. 10.

The end gain is inversely proportional to the difference-sum S, and ranges between 0 and 1. Larger sum value means larger data value difference between pixels in a corresponding block. In this case, an increase in power consumption occurs. For this reason, it is necessary to reduce the data value difference between pixels through a multiplication of an end gain value.

When the difference-sum S for each block is 0, the end gain value for each block corresponds to 1. As the difference-sum for each block increases, the end gain value for each block decreases. Such an end gain value for each block may be experimentally set, and stored in a form of a lookup table for subsequent use thereof. If necessary, the gain value for each block may vary within a range causing no modification of the original image signal. Also, the gain value for each block may be designed to be more than 1.

The address data generator 340 multiplies the image signal by the gain for each block output from the gain determiner 314, thereby outputting corrected data. The address data generator 340 converts the corrected data into a gray scale data signal. All gray scale data signals are sorted in accordance with the gray scales thereof, and are arranged to meet a predetermined driving sequence. The address data generator 340 outputs the arranged data signals to the address electrode driver 200 as address data.

The address data driver 200 applies a voltage corresponding to the received address data to the address electrode lines. Thus, image is displayed on the PDP 100.

As is apparent from the above description, when the data value difference between pixels in a specific block of an input image signal is large, it is multiplied by an end gain for the specific block to reduce the number of switching operations to be conducted. Accordingly, it is possible to reduce power consumption.

Meanwhile, end gain values stored in the lookup table of the gain storing unit 313 in the present embodiment of the present invention are values experimentally determined, taking into consideration noise and power consumption. For this reason, although it is possible to reduce instantaneous power consumption, and generation of heat and noise, a decrease in brightness may occur.

In order to appropriately control instantaneous power consumption, generation of heat and noise, and brightness together, a means is provided in accordance with another embodiment of the present invention.

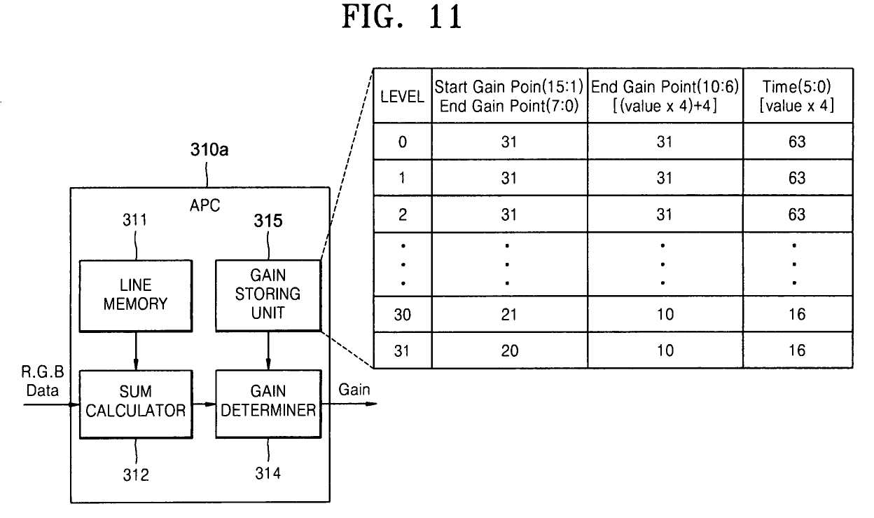

FIG. 11 is a block diagram illustrating an address power controller 310a according to another embodiment of the present invention. As shown in FIG. 11, the address power controller 310a includes a line memory 311 to store an input image signal in units of blocks and lines, and a sum calculator 312 to calculate pixel value differences between adjacent ones of the successive lines of each block stored in the line memory 311, to add the calculated pixel value differences, and thus, to derive the sum of line pixel value differences of each block for one frame. The address power controller 310 also includes a gain storing unit 315 and a gain determiner 314. The gain storing unit 315 stores a start gain, an end gain, and a sustain time corresponding to the sum of line pixel value differences of each block for one frame. The gain determiner 314 determines an address APC level corresponding to the difference-sum for each block derived by the sum calculator 312, reads the start gain, the end gain, and the sustain time corresponding to the determined APC level for each block from the gain storing unit 315, and outputs a gain, which initially corresponds to the start gain, sustains the start gain for the sustain time, and is sequentially decremented by a predetermined value from the start gain until the gain corresponds to the end gain.

An operation of the address power controller 310a having the above-described configuration according to the embodiment of FIG. 11 will be described.

The operation of the address power controller 310a according to the embodiment of FIG. 11 is similar to that of the embodiment of FIG. 9. In the embodiment of FIG. 11, the information in the gain storing unit 315 is stored in the form of a lookup table, which is classified into start gains for blocks, end gains for blocks, and sustain times for blocks.

In the embodiment of FIG. 11, after the gain determiner 314 determines the address APC level for each block of an input image signal having R (red), G (green), and B (blue) components, it receives a start gain for each block, an end gain for each block, and a sustain time for each block from the lookup table.

Then, when the gain determiner 314 outputs the start gain for each block corresponding to the address APC level for each block, the address data generator 340 multiplies the input image signal having the R, G, and B components by the start gain for each block. The gain for each block initially corresponds to the start gain, and sustains the start gain for the sustain time. The gain for each block is then sequentially decremented by a predetermined value from the start gain after every gain output until the gain corresponds to the end gain for each block. Then, the gain sustains the end gain.

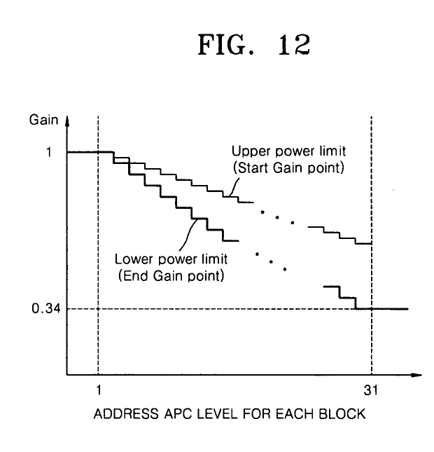

FIG. 12 is a graph depicting a gain varying depending on the address APC level for each block of FIG. 11. Referring to FIG. 12, it can be seen that the start gain for each block and the end gain for each block vary depending on the address APC level for each block, and the difference between the start gain and the end gain increases at a higher APC level for each block. The output gain is decremented from the start gain by a predetermined value until the output gain reaches the end gain. Subsequently, the output gain is sustained at a value corresponding to the end gain.

It can also be seen that the start gain for each block and the end gain for each block vary depending on the address APC level for each block, the time from the start gain to the end gain is shortened at a higher address APC level, and the falling slope of the gain is gentle at a low address APC level, while being sharper at a higher address APC level.

In the embodiment of FIG. 11, the start gain multiplied by the R (red), G (green), and B (blue) image signals varies depending on the address APC level of the image signal for each block. Accordingly, it is possible to completely control instantaneous power consumption, generation of heat and noise, and brightness.

In a contemporary method of calculating a sum of pixel value differences between adjacent lines of the successive lines of an image signal for the entire image screen, when the sum of line pixel value difference for some of the columns of the screen rapidly increases, the rapid increase is not so much high as compared with the entire screen. Thus, the number of address switching operations for the corresponding columns is not reduced. In this case, power consumption, noise, and generation of heat is very highly generated in some of the columns whose line pixel value difference sum rapidly increases.

On the other hand, in a method of calculating a sum of pixel value differences between adjacent lines of the successive lines of an image signal for each block according to the present invention, even when the sum of line pixel value difference for some of the columns rapidly increases, the number of address switching operations for the corresponding columns is reduced. Therefore, power consumption, noise, and generation of heat in the corresponding columns are greatly reduced.

As is apparent from the above description, the present invention provides a method and apparatus to automatically control power of address data in a PDP, which reduce power consumption, generation of heat and noise while achieving an improvement in brightness, and a PDP device including the apparatus.

In particular, an automatic power control for address data in a PDP is carried out in units of blocks each including at least one column, thereby further reducing the power consumption, noise, and generation of heat.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus to automatically control power of address data in a plasma display panel that includes a plurality of pixels for displaying an image, the pixels being arranged in a two-dimensional array having lines and columns, the apparatus comprising:
a memory to store sustain discharge information as a function of a load ratio;
an average signal level sensor to measure a load ratio of an externally input image signal, the input image signal representing pixel values for the pixels;
a power controller coupled to the average signal level sensor and the memory, the power controller reading sustain discharge information corresponding to the measured load ratio of the input image signal, the power controller outputting the sustain discharge information;
an address power controller receiving the input image signal, the two-dimensional array including a plurality of blocks, each of the blocks including at least one column of the array, the address power controller calculating a difference-sum for each of the blocks, the difference-sum being calculated by adding differences between pixel values of neighboring pixels that are successively arranged along a column of the array and are included in the each of blocks, the address power controller obtaining a gain for the each of the blocks on a basis of the difference-sum for the each of the blocks; and
an address data generator coupled to the address power controller, the address data generator receiving the input image signal, the address data generator multiplying the gain for each of the blocks by the input image signal corresponding to the each of the blocks to generate address data.

2. The apparatus of claim 1, wherein each of the blocks comprises only one column of the array.

3. The apparatus of claim 1, wherein the address power controller comprises:
a line memory to store the input image signal in units of blocks and lines;
a sum calculator coupled to the line memory and calculating the difference-sum for each of the blocks;
a gain storing unit to store a gain look-up table that includes a gain as a function of an address auto power control (APC) level; and
a gain determiner coupled to the sum calculator and the gain storing unit, the gain determiner determining an address APC level corresponding to the difference-sum for the each of the blocks that is calculated in the sum calculator, the gain determiner reading a gain corresponding to the determined address APC level from the gain look-up table, the gain determiner outputting the gain for the each of the blocks.

4. The apparatus of claim 3, wherein the gain for each of the blocks is inversely proportional to the difference-sum for the each of the blocks.

5. The apparatus of claim 1, wherein the address power controller comprises:
a line memory to store the input image signal in units of blocks and lines;
a sum calculator coupled to the line memory and calculating the difference-sum for each of the blocks;
a gain storing unit to store a gain look-up table that includes a start gain, an end gain, and a sustain time, each of which is a function of an address auto power control (APC) level; and
a gain determiner coupled to the sum calculator and the gain storing unit, the gain determiner determining an address APC level corresponding to the difference-sum for the each of the blocks that is calculated in the sum calculator, the gain determiner reading a start gain, an end gain, and a sustain time corresponding to the determined address APC level for each block from the gain storing unit, the gain determiner outputting a gain whose level is no greater than the start gain and no less than the end gain.

6. The apparatus of claim 5, wherein the gain is decremented by a predetermined value from the start gain to the end gain, the gain sustaining a level for the sustain time, a time necessary for the gain decreasing from the start gain to the end gain being shortened at a higher address auto power control level, a falling slope of the gain with time being smaller at a lower address auto power control level.

7. The apparatus of claim 5, wherein:
the end gain is 1 when the difference-sum is 0;
the end gain for each block decreases as the difference-sum increases; and
the end gain ranges between 0 and 1.

8. The apparatus of claim 5, wherein the sustain time is shortened as the address auto power control level increases.

9. The apparatus of claim 1, wherein if the each of the blocks has N lines and M columns, the difference-sum S for the each of the blocks is calculated by the following equation:
$$S = {\sum }_{I = 1}^{N} {\sum }_{J = 1}^{M} ( {P}_{i + 1 , j} - {P}_{i , j} )$$
where P represents a pixel value, i represents a line, and j represents a column.

10. The apparatus of claim 1, wherein the address data generator corrects data of the image signal, converts the corrected image data signals into gray scale data signals, sorts the gray scale data signals in accordance with gray scales thereof, arranges the sorted gray scale data signals to meet a predetermined driving sequence, and outputs the arranged data signals.

11. A method of automatically controlling power of address data in a plasma display panel that includes a plurality of pixels for displaying an image, the pixels being arranged in a two-dimensional array having lines and columns, the two-dimensional array including a plurality of blocks, each of the blocks including at least one column of the array, the method comprising:
receiving externally input image signal;
calculating a difference-sum for each of the blocks, the difference-sum being calculated by adding differences between pixel values of neighboring pixels that are successively arranged along a column of the array and are included in the each of blocks;
determining an address power control level corresponding to the calculated difference-sum for each of the blocks;
obtaining a gain for each of the blocks on the basis of the address power control level for each of the blocks; and
multiplying the gain for each of the blocks by the input image signal corresponding to the each of the blocks to correct the input image signal.

12. The method of claim 11, wherein each of the blocks comprises only one column of the array.

13. The method of claim 11, wherein the step of obtaining the gain for each of the blocks including a step of looking up a gain look-up table that includes a gain as a function of an address auto power control (APC) level.

14. The method of claim 11, wherein the step of obtaining the gain for each of the blocks including a step of looking up a gain look-up table that includes a start gain, an end gain, and a sustain time, each of which is a function of an address auto power control (APC) level, the gain having a level no greater than the start gain and no less than the end gain.

15. The method of claim 14, wherein:
the end gain for each of the blocks decreases as the address auto power control level increases; and
the sustain time for each block is shortened as the address auto power control level increases.

16. The method of claim 11, further comprising:
converting the corrected image signals into gray scale data signals;
sorting the gray scale data signals in accordance with gray scales thereof;
arranging the sorted gray scale data signals to meet a predetermined driving sequence; and
outputting the arranged data signals.
